(19) United States
(12) Patent Application Publication
(10) Pub. No.: US 2011/0109013 A1
(43) Pub. Date: May 12, 2011

(54) PROCESS FOR PRODUCING THERMOPLASTIC RESIN COMPOSITION AND PROCESS FOR PRODUCING MOLDED THERMOPLASTIC RESIN

(75) Inventor: Masanori Hashiba, Aichi (JP)

(73) Assignee: TOYOTA BOSHOKU KABUSHIKI KAISHA, Aichi (JP)

(21) Appl. No.: 12/673,855

(22) PCT Filed: Oct. 7, 2008
(86) PCT No.: PCT/JP2008/068246

§ 371 Date: Feb. 17, 2010

(30) Foreign Application Priority Data
Oct. 26, 2007 (JP) 2007-279575

(51) Int. Cl. B29C 45/00; B29C 47/00

(52) U.S. Cl. 264/299; 264/328.1

(57) ABSTRACT

The object of the present invention is to provide a method for producing a thermoplastic resin composition that contains a vegetable material in a large amount of 50% or more by weight and is capable of being pelletized so as to exhibit high fluidity, and to a method for producing a molded article of a thermoplastic resin. The present production method for the composition is one for producing a thermoplastic resin composition which comprises a vegetable material and a thermoplastic resin, and contains the vegetable material in an amount of 50% to 95% by weight based on 100% by weight of the vegetable material and the thermoplastic resin, and is characterized by comprising a mixing process for mixing the vegetable material such as kenaf core and kenaf fiber, and the thermoplastic resin such as polypropylene and polylactic acid using a mixer, and a pelletizing process for pressing the mixture obtained in the mixing process to form a pellet. In the present production method for the molded article, the thermoplastic resin composition is subjected to extrusion molding or injection molding to form a molded article.

### FIELD OF THE INVENTION

The present invention relates to a method for the production of a thermoplastic resin composition and to a method for the production of a molded article comprising the thermoplastic resin composition. Specifically, the present invention relates to a method for the production of a thermoplastic resin composition containing a vegetable material in a large amount of 50% to 95% by weight, and to a method for the production of a molded article comprising the thermoplastic resin composition.

### BACKGROUND ART

In recent years, a vegetable material such as kenaf which grows fast and has large carbon dioxide absorption has been noticed from the viewpoints of reduction in carbon dioxide emission amount, carbon dioxide immobilization, and the like. And a combined use of the vegetable material with a resin has been expected.

However, it is considerably difficult to mix a large amount of the vegetable material with a resin and to further mold the thus-obtained composite material. This is because of the difficulty of imparting a satisfactory fluidity which is equivalent to that of the conventional resin to the composite material. Technologies for handling the composite material containing a large amount of the vegetable material are disclosed in the following Patent Documents 1 and 2.

### [Patent Document 1]

Japanese Patent Application Publication No. JP-A 2005-105245

### [Patent Document 2]

Japanese Patent Application Publication No. JP-A 2000-219812

### DISCLOSURE OF THE INVENTION

### Problems that the Invention is to Solve

PATENT DOCUMENT 1 and PATENT DOCUMENT 2 disclose mixing of a vegetable material and a resin by using a kneader and a bunbury mixer respectively, and, further, pelletization of the obtained material.

However, PATENT DOCUMENT 1 suggests that problems such as a failure in obtaining satisfactory shape and form in a product occur in injection molding since fluidity of a resin composition is remarkably reduced in the case where a content of a kenaf fiber exceeds 50% by weight. In short, it suggests that it is difficult to mix the vegetable material in a large amount of more than 50% by weight.

On the other hand, PATENT DOCUMENT 2 suggests that, in the case where only a vegetable fiber is added to a resin without adding rosin or a plasticizer to the resin, it is difficult to lead to uniformly dispersing of the vegetable fiber, and affinity between the resin and the vegetable material is poor, thereby resulting in a material that has inferior strength and the like, lacks in quality uniformity, and has poor practicability. In a word, it suggests that it is necessary to add additives though it is possible to mix the vegetable material in a large amount of 50% or more by weight.

As detailed above, it has been difficult to mix a large amount of a vegetable material with a resin, and in order to mix them together, it is necessary to use some sort of additive.

Additionally, when the obtained composite material is molded, it is generally necessary to pelletize it. The reason is that a material having uniform shape and size is required from the viewpoints of highly automated mechanism of the molding machine and automatically measuring an amount of the resin or the like to be fed into the machine. However, it is difficult to perform the pelletization while satisfactorily maintaining a mixed state of two materials having small affinity, and the pelletization is not desirable from the viewpoint of a resin heat history since the resin has to be molten in three processes in order to obtain a molded article: mixing process, pelletizing process, and molding process.

The present invention has been accomplished in view of the above-described circumstances, and an object thereof is to provide a method for producing a thermoplastic resin composition that contains a vegetable material in a large amount of 50% or more by weight and is capable of being pelletized so as to exhibit high fluidity, and to a method for producing a molded article of a thermoplastic resin.

### Means for Solving the Problems

The present invention is as follows.

(1) A method for producing a thermoplastic resin composition which comprises a vegetable material and a thermoplastic resin, and contains the vegetable material in an amount of 50% to 95% by weight based on 100% by weight of the vegetable material and the thermoplastic resin, characterized by comprising:

a mixing process for mixing the vegetable material and the thermoplastic resin using a mixer, and

a pelletizing process for pressing the mixture obtained in the mixing process to form a pellet.

(2) The method for producing a thermoplastic resin composition according to (1) above,

wherein the mixer has a mixing chamber for mixing and a mixing blade disposed in the mixing chamber, and

wherein the mixing process is a process in which the thermoplastic resin molten by rotation of the mixing blade and the vegetable material are mixed in the mixing chamber.

(3) The method for producing a thermoplastic resin composition according to (1) or (2) above, wherein the vegetable material is a kenaf.
(4) The method for producing a thermoplastic resin composition according to any one of (1) to (3) above, wherein the thermoplastic resin is at least one of a polypropylene and a polylactic acid.
(5) A method for producing a molded article of a thermoplastic resin, characterized in that the thermoplastic resin composition obtained by the method for production of a thermoplastic resin composition according to any one of (1) to (4) above is subjected to extrusion molding or injection molding to a molded article.

### Effect of the Invention

According to the method for producing a thermoplastic resin composition of the present invention, it is possible to obtain a thermoplastic resin composition containing a vegetable material in a large amount of 50% or more by weight and being pelletized while achieving high fluidity. Particularly, the fluidity is so excellent that the composition is subjected to injection molding, and the composition is capable of suppressing an injection pressure and has excellent moldability. Additionally, the thermoplastic resin composition with high productivity can be produced reducing a formation time for pelletization. Further, since heating is not required to soften or melt the thermoplastic resin in the pelletizing process, it is possible to reduce the number of heating times of the thermoplastic resin composition, and it is possible to obtain a molded article having excellent mechanical properties.

In the case where the mixing process is a process in which the thermoplastic resin molten by rotation of the mixing blade and the vegetable material are mixed in the mixing chamber, it is possible to perform the mixing in a very short time. In addition, it is possible to produce the thermoplastic resin composition without heating from the outside. Further, since neither heating nor using the separate heating unit or the like is required, and since it is possible to perform the mixing in a short time, it is possible to produce the thermoplastic resin composition at a low cost.

In the case where the vegetable material is a kenaf, the kenaf is a very fast growing annual grass. Since the kenaf has excellent absorbitity of carbon dioxide, it can contribute to reducing an amount of carbon dioxide in the air, thus effectively utilizing forest resources and others.

In the case where the thermoplastic resin is a polypropylene and/or a polylactic acid, it is possible to obtain a thermoplastic resin composition having excellent environmental characteristics. Particularly, it is possible to achieve high mechanical properties (strength, etc.) by the combination with the vegetable marital while exploiting the excellent low environmental load and lightweight (polypropylene) and/or a characteristic of being a nonpetroleum resin which is capable of biosynthesis (polylactic acid).

According to the method for producing a molded article of a thermoplastic resin, the thermoplastic resin composition can be subjected to extruding molding and injection molding in spite of containing a large quantity of vegetable material in the composition. Further, excellent moldability can be obtained and a molding can be performed having excellent productivity. In addition, a molded article having high mechanical properties can be obtained.

### BRIEF DESCRIPTION OF THE DRAWINGS

FIG. 1 is a graph showing a change in flexural modulus, a change in injection pressure, and a change in preparation speed in the case of comparing Examples and Comparative Examples;

FIG. 2 is a schematic diagram for explaining processes in the method for producing a thermoplastic resin composition of the present invention;

FIG. 3 is a schematic perspective view showing one example of a main part of a roller disc die molding machine;

FIG. 4 is a schematic sectional view showing one example of a mixer; and

FIG. 5 is a schematic side view showing one example of mixing blades provided in the mixer.

### EXPLANATION OF THE REFERENCE NUMBERS

1: mixer, 3: mixing chamber, 5: rotating shaft, 10 and 10a to 10f: mixing blade, 12: helical blade, 13: material supplying chamber, 500: roller disc die molding machine (pelletizing machine), 50: roller disc die molding part (pelletizing part), 51: disc die, 511: through hole, 512: main rotation shaft insertion hole, 52: press roller, 521: irregularity, 53: main rotation shaft, 54: press roller fixed shaft, 55: cutting blade.

### BEST MODE FOR CARRYING OUT THE INVENTION

Hereinafter, the present invention is described in detail.

### [1] Method for Production of Thermoplastic Resin Composition

The method for the production of a thermoplastic resin composition of the present invention is a method for production of a thermoplastic resin composition which comprises a vegetable material and a thermoplastic resin, and contains the vegetable material in an amount of 50% to 95% by weight based on 100% by weight of the vegetable material and the thermoplastic resin, and is characterized by comprising sequentially, a mixing process for mixing the vegetable material and the thermoplastic resin using a mixer, and a pelletizing process for pressing the mixture obtained in the mixing process to form a pellet.

The above-mentioned “mixing process” is a process in which the vegetable material and the thermoplastic resin are mixed with a mixing machine.

The above-mentioned “vegetable material” is a material derived from a plant. The vegetable material may be a vegetable material obtained from various kinds of plants such as kenaf, jute hemp, manila hemp, sisal hemp, gampi, Mitsumata, Kozo, banana, pineapple, coconut, corn, sugarcane, bagasse, palm, papyrus, reed grass, esparto, Sabi grass, oat, rice plant, bamboo, various conifer trees (Japanese cedar, Japanese cypress, and others), broad leaf tree, cotton and others. These vegetable materials may be used singly or in combination of two or more types thereof. Among these, kenaf is preferred. The kenaf is a very fast growing annual grass and has excellent absorbitity of carbon dioxide so that it can contribute to reducing an amount of carbon dioxide in the air, thus effectively utilizing forest resources and others.

The segment of the plant used as the above-mentioned plant fiber is not particularly limited so long as the segment comprises a segment constituting the plant such as woody parts, non-woody parts, leaf parts, stalk section and root parts. Furthermore, only a specific segment thereof may be used or a different segment with two parts or more may be used. Among these, woody parts of the kenaf (kenaf core) are preferably used.

The kenaf consists of an outer layer part which is called bast and a core material part which is called core. The bast has a high utility value since it contains a strong fiber, but the core is usually discarded or used for a fuel though it has a proportion of about 60% by volume in an overall kenaf. Since the core has a shorter fiber length and a smaller apparent specific gravity and is more bulky as compared to the bast, the core has a poor handling property, and it is difficult to mix with a resin. However, according to the present method, it is possible to easily mix the kenaf core with a thermoplastic resin by the mixing process. What is more, an effect of reinforcing the thermoplastic resin is excellent, and a molded article of the thermoplastic resin to be obtained achieves excellent mechanical properties.

The kenaf according to the present invention is an easy-growing annual grass having a woody stem and a plant classified into malvaceae in the present invention. The kenaf includes hibiscus cannabinus and hibiscus sabdariffa of scientific names, and further includes Indian hemp, Cuban kenaf, kenaf, roselle, mesta, bimli hemp, ambary hemp, Bombay hemp and the like of common names.

The jute according to the present invention is a fiber obtained from a jute hemp. The jute hemp includes a hemp including ouma (Corchorus capsularis L.), Jew's mallow, East Indian mallow, Mulukhiyya and a plant in Tiliacea.

The shape of the vegetable material (vegetable material before mixing) is not particularly limited. The vegetable material may be a chip-like form (including plate-like, flaky, etc.), a powder (including grains, a spherical powder, etc.), a fibrous form, or a form having various shapes (pulverized powder, etc.). The vegetable material may have one kind of the shape or two or more kinds of the shapes in combination.

Further, the size of the vegetable material to be used is not particularly limited. For example, the maximum length (maximum grain diameter in the case of grains) may be 20 mm or shorter. It is generally 0.1 mm or longer and is preferably in the range from 0.3 to 15 mm, more preferably from 0.3 to 20 mm, and further preferably from 0.5 to 10 mm.

In the thermoplastic resin composition obtained by the present method, the form and the size of the vegetable material before mixing may be or may not be maintained as they are. Examples of the case wherein the form and the size are not maintained include a case wherein the vegetable material is pulverized into a finer powder in the mixing to be contained in the thermoplastic resin composition.

The above-mentioned “thermoplastic resin” is not limited in particular, and various thermoplastic resins can be used. For example, a polyolefin such as polypropylene and polyethylene, a polyester resin including an aliphatic polyester resin such as polylactic acid and polycaprolactone, and an aromatic polyester resin such as polyethylene terephthlate, polystyrene, a polyacrylic resin such as methacrylate and acrylate, a polyamide resin, a polycarbonate resin, a polyacetal resin and the like may be used. These resins may be used singly or in combination of two or more types thereof.

Among these, at least one of a polyolefin and a polyester resin are preferred. Additionally, a polypropylene is preferable as the polyolefin.

On the other hand, the polyester resin is preferably a polyester resin having biodegradability (hereinafter, referred to simply as “biodegradable resin”). Examples of the biodegradable resin include (1) a hydroxycarboxylic acid-based aliphatic polyester such as a homopolymer of hydroxycarboxylic acid including lactic acid, malic acid, glucosic acid or 3-hydroxybutyric acid and a copolymer using at least one of the above-listed hydroxycarboxylic acids, (2) a caprolactone-based aliphatic polyester such as polycaprolactone and a copolymer of at least one of the above-listed hydroxycarboxylic acid and caprolactone, (3) a dibasic acid polyester such as polybutylene succinate, polyethylene succinate and polybutylene adipate, and the like. Among these, polylactic acid, a copolymer of lactic acid and a hydroxycarboxylic acid except lactic acid, polycaprolactone, and a copolymer of caprolactone and at least one kind of a hydroxycarboxylic acid are preferable. Polylactic acid is particularly preferable.

The biodegradable resin may be used singly or in combination of two or more types thereof.

It is noted that the lactic acid includes L-lactic acid and D-lactic acid and that the lactic acid may be used singly or in combination.

The shape and size of the thermoplastic resin to be used in the mixing process is not particularly limited. The maximum length (maximum grain diameter in the case of grains) may be 20 mm or shorter. It is generally 0.1 mm or longer and is preferably in the range from 0.3 to 15 mm, more preferably from 0.3 to 20 mm, and further preferably from 0.5 to 10 mm.

The “mixer” is a device for mixing the vegetable material and the thermoplastic resin. The mixer is not particularly limited so long as the vegetable material and the thermoplastic resin can be mixed. For example, a mixer (including mixing machine and kneading machine) such as an extruder (uniaxial screw extruder, twin-screw kneading extruder, etc.), a kneader, and a mixer (high speed fluid mixer, paddle mixer, ribbon mixer, etc.) may be used. The following mixer is particularly preferred.

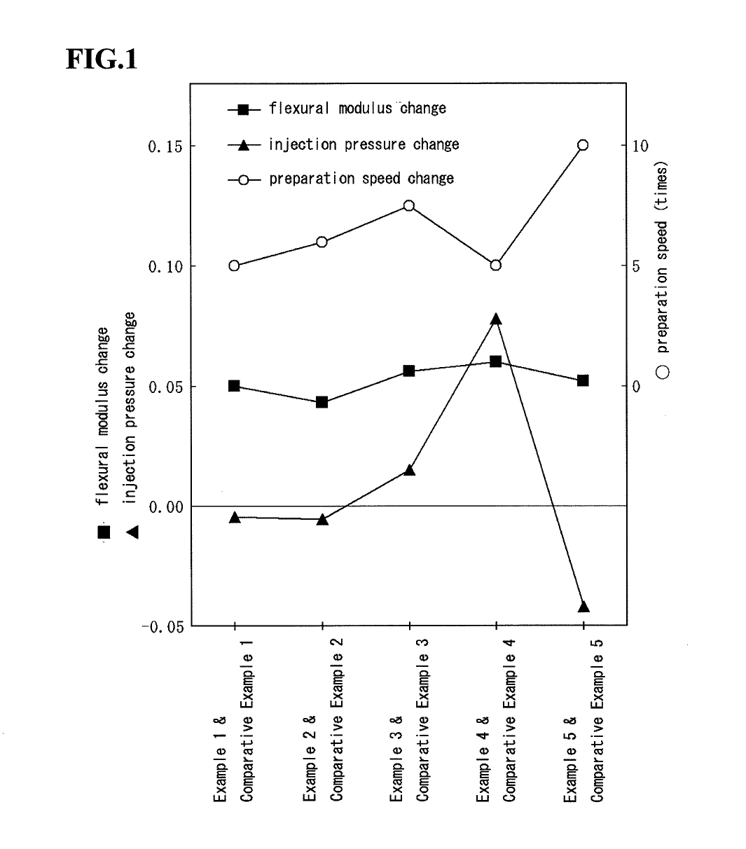

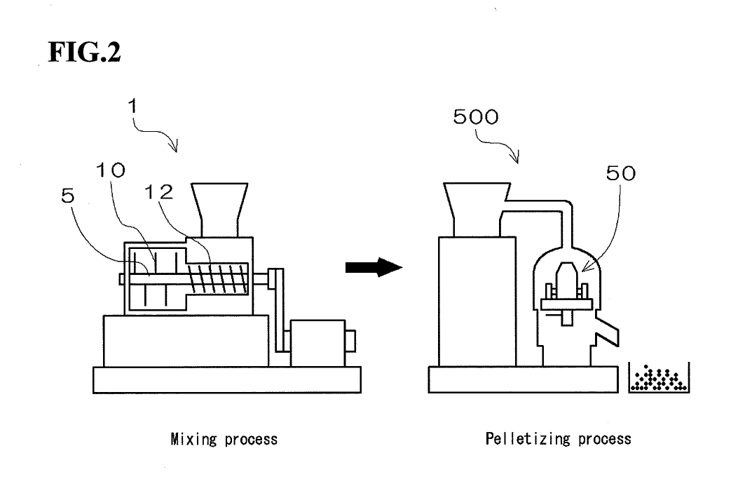

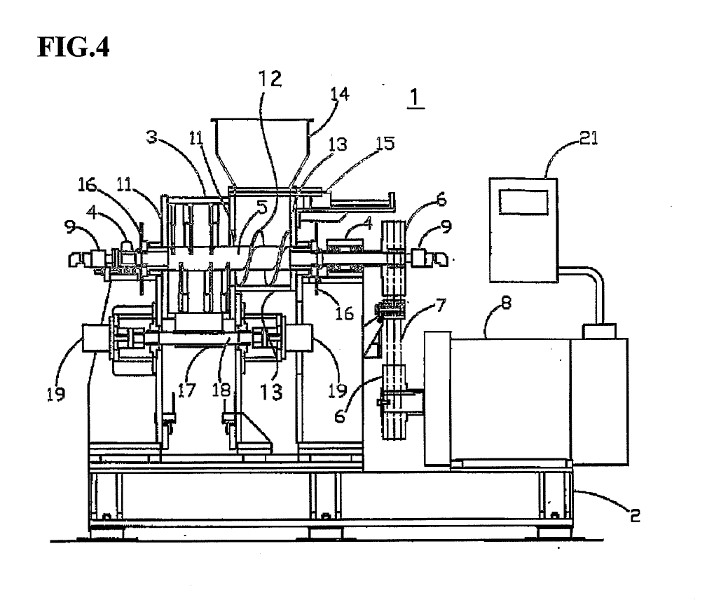

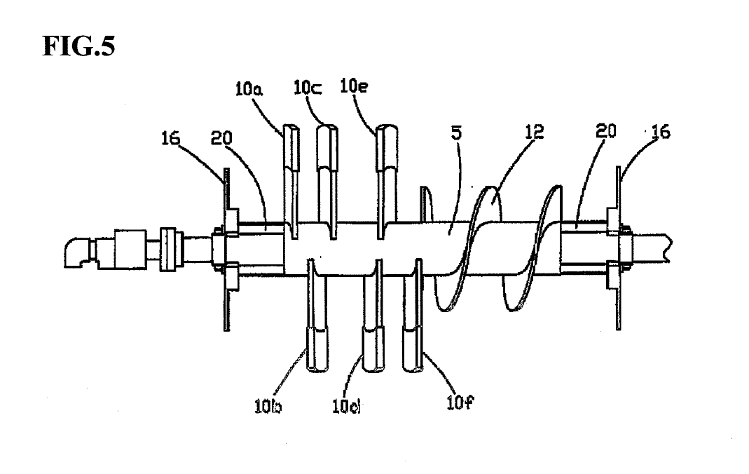

As the mixer (hereinafter, refer to FIG. 4 (citing FIG. 1 of International Publication No. 04/076044 provided in Industrial Property Digital Library of Japanese Patent Office) and FIG. 5 (citing FIG. 2 of International Publication No. 04/076044 provided in Industrial Property Digital Library of Japanese Patent Office), the mixer 1 disclosed in International Publication No. 04/076044 is preferred. That is, the mixer 1 is preferably a mixer that is provided with a material supplying chamber 13, a mixing chamber 3 communicated with the material supplying chamber 13, a rotating shaft 5 penetrating through the material supplying chamber 13 and the mixing chamber 3 and provided rotatably, a helical blade 12 which is provided on the rotation shaft 5 in the material supplying chamber 13 and feeds the mixed materials (vegetable material and thermoplastic resin) supplied to the material supplying chamber 13 to the mixing chamber 3, and mixing blades 10a to 10f which are provided on the rotation shaft 5 in the mixing chamber 3 and mix the mixed materials.

When the mixer is used for charging of the vegetable material and the thermoplastic resin into the mixer 1 (material supplying chamber 13) and for rotation of the mixing blades 10a to 10f of the mixer 1, the vegetable material and the thermoplastic resin are pounded together in such a manner as to be pressed and moved toward an inner wall of the mixing chamber 3, so that the thermoplastic resin is softened or molten in a short time by energy (heat quantity) of the collision between the materials, mixed with the vegetable material, and then kneaded. The obtained mixture (thermoplastic resin composition before pelletization) exhibits excellent fluidity that enables injection molding.

The mixing blades 10a to 10f are opposed in a shaft direction as being located at positions with a certain angular interval being defined along a circumferential direction of the rotation shaft 5 and formed of at least two mixing blades (10a to 10f) that are provided on the rotation shaft 5 at a mounting angle that narrows the opposed interval in a rotation direction. The mounting angle of the mixing blades 10a to 10f with respect to the rotation shaft 5 is preferably identical from a base to a tip in a radially external direction of the mixing blades 10a to 10f mounted on the rotation shaft 5. Further, it is preferable that each of the mixing blades 10a to 10f has a rectangular shape.

Additionally, the mixing chamber preferably is provided with further a mixing chamber cooling unit that is capable of circulating a cooling medium along walls forming the mixing chamber. With such constitution, it is possible to suppress an excessive temperature rise inside the mixing chamber as well as to suppress (and prevent) decomposition and heat deterioration of the thermoplastic resin.

The conditions for the “mixing” are not particularly limited. The temperature during the mixing is not particularly limited and the temperature of an outer wall of the mixing chamber is preferably controlled to 200° C. or lower, more preferably 150° C. or lower, and further preferably 120° C. or lower, and preferably 50° C. or higher, more preferably 60° C. or higher, and further preferably 80° C. or higher. The temperature may preferably be attained within 10 minutes and more preferably within 5 minutes. Controlling to the high temperature in a short time leads to a rapid evaporation of moisture and the mixing. And it is possible to more effectively suppress the deterioration of the thermoplastic resin. Also, the temperature range may preferably be maintained for 15 minutes or shorter and more preferably 10 minutes or shorter.

Further, when the rotation speed of the mixing blades of the mixer is adjusted, the temperature can be controlled. Specifically, the mixing blades may be controlled so that a rotation speed of the tips is in the range from 5 to 50 m/sec. This rotation speed controlling to the specified range leads to a mixing the thermoplastic resin with the vegetable material more strongly (uniformly) while softening or melting the thermoplastic resin.

Further, an end point in the mixing is not particularly limited and the end point may be decided by a change in torque loaded on the rotation shaft. It is preferable to measure the torque loaded on the rotation shaft and to stop the mixing after the torque has reached a maximum value. Thus, it is possible to mix the vegetable material and the thermoplastic resin while attaining good mutual dispersibility. Further, it is more preferable to stop the mixing when the torque starts to diminish after having reached the maximum value. It is particularly preferable to stop the mixing within a torque of 40% or higher, and more preferably a range from 50% to 80% with respect to the maximum torque. Thus, it is possible to mix the vegetable material and the thermoplastic resin while attaining good mutual dispersibility as well as to take out the mixture (thermoplastic resin composition before pelletization) from the inside of the mixing chamber at a temperature of 160° C. or higher, thereby more reliably preventing the thermoplastic resin composition from adhering to and remaining in the mixing chamber.

The mixing ratio of the vegetable material and the thermoplastic resin used in the mixing process is not limited insofar as a content of the vegetable material in the mixture to be obtained becomes 50% to 95% by weight. It is preferably 50% to 90% by weight, more preferably 52% to 87% by weight, further preferably 54% to 85% by weight, furthermore preferably 56% to 83% by weight, specifically 58% to 80% by weight, and particularly 60% to 75% by weight. The above-specified range enables to prominently improve a pellet preparation speed while maintaining an injection pressure during molding as compared to employing other pelletizing process (other pelletizing method). In addition, it is possible to achieve a reinforcing effect by the mixing of the vegetable material with the thermoplastic resin, and the flexural modulus can be improved. Further, it is possible to further enhance the effects within the preferred ranges.

The above-mentioned ratio (content ratio) between the vegetable material and the thermoplastic resin is the same as that in the pelletized thermoplastic resin composition.

The “pelletizing process” is a process of forming pellets (pelletized thermoplastic resin composition) by pressing the mixture (thermoplastic resin composition before pelletization) obtained by the mixing process. Generally, the pelletization of the thermoplastic resin composition is performed using a twin-screw extruder, but the pelletization in the present method is performed by press-solidification. Such pelletization leads to a high productivity due to the prominent improvement in pelletizing speed for the thermoplastic resin composition containing the vegetable material in a large amount of 50% or more by weight, though the exact reason for the pelletizing speed improvement has not been clarified yet. For example, it is difficult to perform the pelletization itself when the mixture does not have satisfactory fluidity in the pelletization using the twin-screw extruder. However, influence of the fluidity of the mixture is considered to be very little in the case of pelletization by press-solidification, and, therefore, it is possible to realize smooth pelletization.

Further, it is considered that the dispersed state of the vegetable material and the thermoplastic resin which is achieved in the mixing process is easily maintained since the pelletization is performed without heating. And it is in some cases possible to improve production efficiency when molding is performed using the pellets obtained by the present method since an injection pressure is suppressed to a smaller value as compared to the cases of employing other method for pelletizing. This effect is prominent particularly when a fibrous vegetable material is used or when a polylactic acid resin is used as the thermoplastic resin.

Additionally, the press-solidification for pelletization is unnecessary to perform heating of the thermoplastic resin unlike the twin-screw extruder by which the thermoplastic resin is softened or molten for pelletization. Therefore, heat deterioration of a molded article to be obtained can be suppressed, thereby making it possible to obtain a molded article having high mechanical properties.

The pelletizing process is a process in which the mixture (the thermoplastic resin composition before pelletization) is subjected to pressing for pelletization, and any device or means may be used for the pelletizing process. It is particularly preferable to use a compression molding method. Examples of the compression molding method include a roller-type molding method, an extrusion-type molding method, and the like. The method for roller-type molding is a method using a roller molding machine, wherein the mixture is pressed into a dice by a rotating roller being in contact with a die, extruded from the dice, and then molded. Examples of the roller molding machine include a disc die type (roller disc die molding machine) and a ring die type (roller ring die molding machine) that are different from each other by a die shape. In turn, the extrusion-type molding method is a method employing an extrusion-type molding machine, wherein the mixture is pressed into a dice by a rotation of screw auger, extruded from the dice, and then molded. Among the methods for compression molding, the roller disc die molding method is particularly preferred. The roller disc die molding machine used in the method for compression molding has high compression efficiency and is particularly suitable for the pelletizing process in the present method.

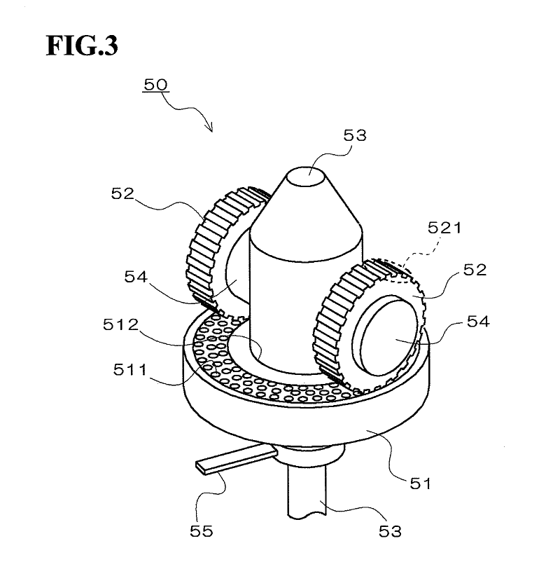

Further, in the present method, it is particularly preferable to perform the pelletization by using a roller disc die molding machine 500 specified below (see, FIG. 2, main part is shown in FIG. 3). That is, the device is a roller disc die molding machine (pelletization device) 500 having a roller disc die molding unit 50 provided with a disk die 51 having a plurality of through-holes 511, a press roller 52 rolling on the disc die 51 for pressing a non-pressurized substance (mixture) into the through-holes 511, and a main rotating shaft 53 for driving the press roller 52, wherein the disc die 51 has a main rotation shaft insertion hole 512 penetrating in a direction same as the through-holes 511; the main rotation shaft 53 has a press roller fixed shaft 54 inserted into the main rotation shaft insertion hole 512 and provided perpendicularly to the main rotation shaft 53; and the press roller 52 is rotatably supported by the press roller fixed shaft 54 and rolls on a surface of the disc die 51 along with the rotation of the main rotation shaft 53.

The roller disc die molding machine 500 has preferably an irregularity 521 on a surface of the press roller 52 in addition to the above-described construction. Additionally, the machine has preferably a cutting blade 55 that is rotated along with a rotation of the main rotation shaft 53.

According to the roller disc die molding machine 500, the mixture charged from above the main rotation shaft 53 is caught by the surface irregularity 521 provided on the press roller 52 to be pressed into the through-holes 511 and then extruded from a back surface side of the disc die 51 in FIG. 3, for example. The extruded strip-like mixture is cut by the cutting blade 55 into an appropriate length to be pelletized, and the pellets fall down to be collected.

The shape and size of the pelletized thermoplastic resin composition are not particularly limited. The shape is preferably columnar (cylindrical shape is particularly preferred among other preferred columnar shapes). The maximum length of the pellet is preferably 1 mm or longer (usually 20 mm or shorter), more preferably in the range from 1 to 10 mm, and particularly from 2 to 7 mm.

The present method can comprise other process in addition to the mixing process and the pelletizing process. Examples of the other process include a process of preparing a material pellets by press-solidifying the vegetable material in advance of the mixing process.

That is, the method for producing a thermoplastic resin composition may comprise:

a starting pellet material preparation process for the formation of a starting pellet material by press-solidifying a vegetable material;

a mixing process for mixing the starting pellet material and a thermoplastic resin using a mixer; and

a pelletizing process for obtaining pellets by press-solidifying the mixture obtained by the mixing process, the process being performed (in this order).

In the starting pellet material preparation process, the roller disc die molding machine 500 can be employing in the same manner as in the pelletizing process.

When the starting pellet material preparation process is provided, the specific gravity of the vegetable material can be closer to that of the thermoplastic resin, and the difference of specific gravity between the vegetable material and the thermoplastic resin can be reduced. Thereby uneven distribution of the materials during mixing can be suppressed and the thermoplastic resin composition can be obtained in which the vegetable material and the thermoplastic resin are mutually and uniformly mixed. Further, a molded article to be obtained has high mechanical strength. Additionally, when the apparent specific gravity of the vegetable material is set to larger, bulkiness can be reduced, handleability can be improved, and the charging of the material into the mixer can be easier. Thus, efficiency for the production of a thermoplastic resin composition is improved.

The method comprising the starting pellet material preparation process is suitably employed when the apparent specific gravity of the vegetable material to be used is smaller than that of the thermoplastic resin. It is preferred particularly in the case where A/B is 0.4 or less (generally A/B is 0.05 or more) when the apparent specific gravity of the vegetable material is A and the apparent specific gravity of the thermoplastic resin is B. In the case where a vegetable material having a small specific gravity in which A/B is 0.4 or less is used, it is difficult to mix the vegetable material with the thermoplastic resin particularly, and production efficiency tends to be reduced. When the starting pellet material preparation process is provided, high mutual dispersibility of the vegetable material and the thermoplastic resin can be obtained. In other words, even when an apparent specific gravity of a vegetable material is much smaller than that of the thermoplastic resin, the vegetable material can be mixed with the thermoplastic resin without uneven distribution. Additionally, the production efficiency for the thermoplastic resin composition is improved. Examples of the vegetable material having the small specific gravity in which A/B is 0.4 or less include the above-mentioned core material of kenaf. As to the specific gravity A/B, the effect is prominent when 0.05≦A/B≦0.3, and is particularly when 0.07≦A/B≦0.25.

Note that the specific gravity (apparent specific gravity) in the present invention means a specific gravity value in the case where the specific gravity is measured in accordance with JIS Z 8807 in an equilibrium moisture regain (10%) (thermoplastic resin is measured by a method for in-liquid weighing; vegetable material is measured by a method for measuring a volume).

Further, in the case of providing the starting pellet material preparation process, a degree of press-solidification in the starting pellet material preparation process is not particularly limited. The press-solidification is preferably performed with C/B at 0.5 or more, more preferably 0.6 or more, further preferably 0.65 or more, and particularly 1.0 or more, when an apparent specific gravity of the starting pellet material is C and an apparent specific gravity of the thermoplastic resin is B. When C/B is 0.5 or more, it is possible to achieve higher dispersibility than in the case of charging without press-solidification, and excellent production efficiency can be obtained. The specific gravity of the starting pellet material is not particularly limited and is preferably in the range from 0.5 to 1.3, and more preferably from 0.7 to 1.25.

In the production method of the present invention, it is possible to add components other than the vegetable material and the thermoplastic resin. Examples of these other components include a carbodiimide compound in the case of using the above-mentioned polyester resin as the thermoplastic resin. Examples of the carbodiimide compound include dicyclohexyl carbodiimide, dicyclohexyl carbodiimide, diisopropyl carbodiimide, 1-ethyl-3-(3-dimethylaminopropyl) carbodiimide hydrochloride, and the like. These compounds may be used singly or in combination of two or more.

The content of the carbodiimide is not particularly limited and is preferably in the range from 0.1 to 5 parts by weight, more preferably from 0.1 to 2 parts by weight, and particularly from 0.5 to 1.0 part by weight based on 100 parts by weight of the total of the polyester resin (particularly, in the case of polylactic acid) to be used. Within the range, it is possible to more effectively achieve a hydrolysis suppression effect of polyester resin (biodegradable resin), which is caused by the use of the carbodiimide compound.

Further, an antistatic agent, a flame retardant, an antibacterial agent, a coloring agent and the like can be incorporated. These agents may be used singly or in combination of two or more types thereof. The process to formulate the other components is not limited and is generally the mixing process. It is unnecessary to use any additive for promoting the mixing of the vegetable material and the thermoplastic resin in the method of the present invention.

### [2] Method for Production of Molded Article

The method for the production of a molded article of the present invention is characterized in that the thermoplastic resin composition (pelletized thermoplastic resin composition) obtained by the method for the production of a thermoplastic resin composition of the present invention is subjected to extrusion molding or injection molding to a molded article. That is to say, the method for producing a molded article of the present invention comprises a molding process of obtaining a molded article by extrusion molding or injection molding the thermoplastic resin composition.

The thermoplastic resin composition contains a large amount of the vegetable material as described above and, at the same time, is capable of exhibiting excellent fluidity. Therefore, since it is possible to reduce a weighing time for molding (weighing time in injection molding machine, etc.), injection time, and the like, to shorten a molding cycle, and to improve molding efficiency. Molding conditions, a device to be used, and the like for extrusion molding and injection molding are not particularly limited, and it is preferable to select appropriate ones depending on a desired molded article, a desired shape, a type of the thermoplastic resin to be used, and the like.

The shape, size, thickness and the like of the molded article obtained by the production method of the present invention are not particularly limited. Additionally, its use application is not particularly limited. The molded article may be used as an interior material, an exterior material, a structural material and others of an automobile, a railcar, a ship, an aircraft and others. Among them, examples of an automobile supplies include an interior material for automobile, an instrument panel for automobile, an exterior material for automobile and others. Specific examples are a door base material, a package tray, a pillar garnish, a switch base, a quarter panel, a core material for armrest, a door trim for automobile, a sheet-structured material, a console box, a dashboard for automobile, various instrument panels, a deck trim, a bumper, a spoiler, a cowling and others. Other examples are an interior material, an exterior material and a structural material of an architectural structure, furniture and others. That is, a door surface material, a door structural material, a surface material and a structural material for various furnitures (desk, chain, shelf, chest, and others), and others are included. Additionally a package, a container (tray and others), a member for protection, a member for partition and others may be included.

### Example

Hereinafter, the present invention is explained in detail using Examples.

### [1] Production of Thermoplastic Resin Composition for Examples 1 to 5

A vegetable material which was kenaf core having a grain diameter of 1 mm or less (for Examples 1 to 3 and Example 5) or a kenaf fiber having a fiber length of 3 mm (for Example 4) and pellets of polypropylene (for Examples 1 to 4) or a polylactic acid resin (for Example 5) shown in Table 1 were charged into a material supplying chamber (denoted by 13 in FIG. 4) of a mixer 1 (it is disclosed in WO2004-076044 and is manufactured by M&F Technology) at weight ratios shown in Table 1 (a total amount of the vegetable material and the thermoplastic resin was 700 g at the amount ratios shown in Table 1) and then kneaded by stirring in a mixing chamber (capacity: 5 L; denoted by 3 in FIG. 4). Mixing blades (denoted by 10 in FIG. 2; denoted by 10a to 10f in FIG. 5) were rotated at a rotation speed of 2,000 rpm for the mixing. After a load (torque) applied on the mixing blades started to increase, the stirring was stopped at an end point which was 6 seconds after the load reached a maximum value (exceeding 100%), and the thus-obtained mixture (thermoplastic resin composition before pelletization, for Examples 1 to 5) was discharged from the mixer.

The kenaf core was crushed by a crusher (“Z10-420” (type name) manufactured by Horai Co, Ltd.), and the grain diameter was achieved by passing the grains through a perforated plate-like sieve having a mesh opening size of 1.0 mm in accordance with JIS Z 8801. The fiber length of the kenaf fiber was an average value by arbitrarily taking out 200 single fibers one by one using a direct method and measuring a fiber length of each of the 200 single fibers on a fixed scale in accordance with JIS L 1015.

In addition, a resin “NOVATEC BC06C” (product name) manufactured by Japan Polypropylene Corp. was used as the polypropylene which has an average particle diameter of 3.0 mm and an apparent specific gravity of 0.9. And a resin “U's S-17” (product name) manufactured by Toyota Motor Corp. was used as the polylactic acid resin which has an average particle diameter of 4 mm and an apparent specific gravity of 1.26.

Each of the thus-obtained mixture was crushed into pieces each having a size of about 5.0 mm by using a crusher (“Z10-420” (type name) manufactured by Horai Co, Ltd.). And then the pieces were charged into a roller disc die molding machine 500 (“KP280” (type name) manufactured by Kikukawa Iron Works Inc.) having a diameter of through hole (denoted by 511 in FIG. 3) of 4.2 mm to obtain cylindrical pellets having a diameter of about 4 mm and a length of about 5 mm (thermoplastic resin compositions in Examples 1 to 5). A pellet preparation speed for preparing the pellets was 30 kg per hour (30 kg/h) in each of Examples 1 to 5 (adjusted in roller disc die molding machine 500). The obtained pellets were dried in an oven at 100° C. for 24 hours.

### [2] Production of Thermoplastic Resin Composition for Comparative Examples 1 to 5

Mixtures (thermoplastic resin compositions before pelletization, for Comparative Examples 1 to 5) made from materials and having composition as shown in Table 1 were obtained by using the mixer in the same manner as in Examples 1 to 5.

After that, each of the obtained mixtures was crushed into pieces each having a size of about 5.0 mm by using a crusher (“Z10-420” (type name) manufactured by Horai Co, Ltd.) and pelletized by using a twin-screw extruder (manufactured by PLABOR Research Laboratory of Plastics Technology Co., Ltd) having screw diameter of 30 mm and L/D of 42 at a barrel temperature of 190° C. The extrusion was performed by adjusting a feed rate of the mixture using a feeder (feeder for supplying the starting material) in such a manner that a toque loaded on a screw of the twin-screw extruder did not exceed an upper limit of 25 kgf·m. Pellet preparation speeds for the pelletization were measured to show the measured values in Table 1. The obtained pellets were dried in an oven at 100° C. for 24 hours.

### [3] Molding of Thermoplastic Resin Molded Article

Each of the pelletized thermoplastic resin compositions of Examples 1 to 5 and Comparative Examples 1 to 5 obtained by the above [1] and [2] was charged into an injection molding machine (“SE100DU” (type name) manufactured by Sumitomo Heavy Industries, Ltd.) and subjected to injection molding under the conditions of a cylinder temperature of 190° C. and a mold temperature of 40° C. to obtain a rectangular plate-like test piece having a thickness of 4 mm, a width of 10 mm, and a length of 80 mm. Injection pressure (injection-filling pressure) in the injection molding machine for performing the molding was measured, and the value was shown in Table 1.

### [4] Physical Evaluation of Thermoplastic Resin Molded Article

Flexural modulus of the molded article for each of the molded articles of Examples 1 to 5 and Comparative Examples 1 to 5 obtained by the above [3] was measured. For the measurement, the rectangular plate-like test piece having a thickness of 4 mm, a width of 10 mm, and a length of 80 mm were used. The test piece was supported at two supporting points (curvature radius: 5 mm) having a support point distance (L) of 64 mm, and a load was applied from an action point (curvature radium: 5 mm) set at the center of the supporting points at a rate of 2 mm/min to measure the flexural modulus of the test piece in accordance with JIS K 7171. The results are shown in Table 1.

Further, numerical comparisons between Examples and Comparative Examples on the thus-measured “pellet preparation speed” measured by the above [1] and [2], “injection pressure” measured by the above [3], and “flexural modulus” measured by this [4] were shown in a graph of FIG. 1.

More specifically, in the case where the measured values of “injection pressure” in Example and Comparative Example were A and B, respectively, a value of (A−B)/B was shown as “injection pressure change” in FIG. 1. Likewise, in the case where the measured values of “flexural modulus” in Example and Comparative Example were A and B, respectively, a value of (A−B)/B is shown as “flexural modulus change” in FIG. 1. Further, in the case where the measured values of “pellet preparation speeds” in Example and Comparative Example were A and B, respectively, a value of A/B is shown as “pellet preparation speed change” (multiplying factor) in FIG. 1.

TABLE 1

| | | Example | | | | |
|---|---|---|---|---|---|---|
| | | 1 | 2 | 3 | 4 | 5 |
| Composition | Vegetable | 50 | 60 | 70 | 60 | 60 |
| | material | (core) | (core) | (core) | (fiber) | (core) |
| | (wt %) | | | | | |
| | Polypropylene | 50 | 40 | 30 | 40 | — |
| | (wt %) | | | | | |
| | Polylactic | — | — | — | — | 40 |
| | acid | | | | | |
| | (wt %) | | | | | |
| Pelletization | Device | Roller disc die molding machine | | | | |
| | Pellet | 30 | 30 | 30 | 30 | 30 |
| | preparation | | | | | |
| | speed | | | | | |
| | (kg/h) | | | | | |
| Molding | Injection | 84 | 104 | 132 | 110 | 182 |
| | pressure | | | | | |
| | (MPa) | | | | | |
| | Flexural | 4200 | 4900 | 5700 | 5300 | 8100 |
| | modulus | | | | | |
| | (MPa) | | | | | |
| | | Comparative Example | | | | |
| | | 1 | 2 | 3 | 4 | 5 |
| Composition | Vegetable | 50 | 60 | 70 | 60 | 60 |
| | material | (core) | (core) | (core) | (fiber) | (core) |
| | (wt %) | | | | | |
| | Polypropylene | 50 | 40 | 30 | 40 | — |
| | (wt %) | | | | | |
| | Polylactic | — | — | — | — | 40 |
| | acid | | | | | |
| | (wt %) | | | | | |
| Pelletization | Device | Twin-screw extruder | | | | |
| | Pellet | 6 | 5 | 4 | 6 | 3 |
| | preparation | | | | | |
| | speed | | | | | |
| | (kg/h) | | | | | |
| Molding | Injection | 88 | 110 | 130 | 102 | 190 |
| | pressure | | | | | |
| | (MPa) | | | | | |
| | Flexural | 4000 | 4700 | 5400 | 5000 | 7700 |
| | modulus | | | | | |
| | (MPa) | | | | | |

### [5] Effects of Examples

It was possible to mix 50% or more by weight of the vegetable material and the thermoplastic resin in all of Examples 1 to 5. Particularly, the vegetable material and the thermoplastic resin could be mixed without adding any additive for promoting the mixing.

The materials to be mixed and the amounts thereof in Example 1 and those in Comparative Example 1 were the same, and the same applies to Example 2 and Comparative Example 3, Example 3 and Comparative Example 3, Example 4 and Comparative Example 4, and Example 5 and Comparative Example 5. However, the molding in Examples 1 to 5 was performed using the pellets obtained by press-solidification, while the molding in Comparative Examples 1 to 5 was performed using the pellets obtained by using the extruder.

As a result, in Example 1 as compared to Comparative Example 1, the injection pressure was reduced by −4.5%, the flexural modulus was strengthened by +5%, and the pellet preparation speed was 5 times that of Comparative Example 1. In Example 2 as compared to Comparative Example 2, the injection pressure was reduced by −5.5%, the flexural modulus was strengthened by +4.3%, and the pellet preparation speed was 6 times that of Comparative Example 2. In Example 3 as compared to Comparative Example 3, the injection pressure was +1.5% which was a very little difference from Comparative Example 3, the flexural modulus was strengthened by +5.6%, and the pellet preparation speed was 7.5 times that of Comparative Example 3. In Example 4 as compared to Comparative Example 4, though the injection pressure was as large as +7.8%, the flexural modulus was strengthened by +6.0%, and the pellet preparation speed was 5 times that of Comparative Example 4. Further, in Example 5 as compared to Comparative Example 5, the injection pressure was reduced by −4.2%, the flexural modulus was strengthened by +5.2%, and the pellet preparation speed was 10 times that of Comparative Example 5. Clearly from the results, in each of the comparisons, it was confirmed that the injection pressure was reduced or suppressed to the slight increase; the mechanical property indicated by the flexural modulus was strengthened; and considerably rapid pellet preparation speed that contributes to good productivity was achieved by obtaining pellets by press-solidification and performing molding by using the thus-obtained pellets. In addition, it is confirmed from the results, that the advantages are prominent in the case of using the core among the vegetable materials, and that the advantages are particularly prominent in the case of using polylactic acid.

### INDUSTRIAL APPLICABILITY

The production method of the thermoplastic resin composition of the present invention and the production method of the molded article of a thermoplastic resin of the present invention are widely used in fields of an automobile, an architecture and others. In particular, the methods are useful for an interior material, an exterior material, a structural material and others of an automobile, a railcar, a ship, an aircraft and others. Among them, examples of an automobile supplies include an interior material for automobile, an instrument panel for automobile, an exterior material for automobile and others. Specific examples are a door base material, a package tray, a pillar garnish, a switch base, a quarter panel, a core material for armrest, a door trim for automobile, sheet-structured material, a console box, a dashboard for automobile, various instrument panels, a deck trim, a bumper, a spoiler, a cowling and others. Other examples are an interior material, an exterior material and a structural material of an architectural structure, furniture and others. That is, a door surface material, a door structural material, a surface material and a structural material for various furnitures (desk, chain, shelf, chest, and others), and others are included. Additionally a package, a container (tray and others), a member for protection, a member for partition and others may be included.

1. A method for producing a thermoplastic resin composition which comprises a vegetable material and a thermoplastic resin, and contains said vegetable material in an amount of 50% to 95% by weight based on 100% by weight of said vegetable material and said thermoplastic resin, comprising:
a mixing process for mixing said vegetable material and said thermoplastic resin using a mixer, and
a pelletizing process for pressing the mixture obtained in said mixing process to form a pellet.

2. The method for producing a thermoplastic resin composition according to claim 1,
wherein said mixer has a mixing chamber for mixing and a mixing blade disposed in said mixing chamber, and
wherein said mixing process is a process in which the thermoplastic resin molten by rotation of said mixing blade and said vegetable material are mixed in said mixing chamber.

3. The method for producing a thermoplastic resin composition according to claim 1, wherein said vegetable material is a kenaf.

4. The method for producing a thermoplastic resin composition according to claim 1, wherein said thermoplastic resin is at least one of a polypropylene and a polylactic acid.

5. A method for producing a molded article of a thermoplastic resin, characterized in that said thermoplastic resin composition obtained by said method for production of a thermoplastic resin composition according to claim 1 is subjected to extrusion molding or injection molding to a molded article.
